(19) United States
(12) Patent Application Publication
(10) Pub. No.: US 2014/0254715 A1
(43) Pub. Date: Sep. 11, 2014

(54) ROBUST PRECODING VECTOR SWITCHING FOR MULTIPLE TRANSMITTER ANTENNAS

(71) Applicant: NOKIA SIEMENS NETWORKS OY, Espoo (FI)

(72) Inventors: Denis BAREEV, Nizhny Novgorod (RU); Bernd BAUMGARTNER, Giengen (DE); Evgeny DOMBROVSKY, Nizhny Novgorod (RU); Markus REINHARDT, Neu-Ulm (DE); Gottfried SCHNABL, Ulm (DE)

(73) Assignee: NOKIA SIEMENS NETWORKS OY, Espoo (FI)

(21) Appl. No.: 13/785,541

(22) Filed: Mar. 5, 2013

(51) Int. Cl. H04B 7/04

(52) U.S. Cl. CPC H04B 7/0456
USPC 375/296

(57) ABSTRACT

Methods, apparatuses, and computer program products for robust precoding vector switching for multiple transmitter antennas are provided. One method includes defining, by a base station, a precoding vector switching (PVS) scheme for transmission of synchronization signals through multiple antennas comprising a plurality of pairs of cross-polarized antenna elements. The PVS scheme includes changing a direction pattern from co-polarized antenna elements for the first and for the second occurrence of the synchronization signals, and rotating a polarization from each of the pairs of cross-polarized antenna elements for the first and for the second occurrence of the synchronization signals.

### BACKGROUND

1. Field

Embodiments of the invention generally relate to wireless communications networks, such as, but not limited to, the Universal Mobile Telecommunications System (UMTS) Terrestrial Radio Access Network (UTRAN) and/or Long Term Evolution (LTE) Evolved UTRAN (E-UTRAN).

2. Description of the Related Art

Universal Mobile Telecommunications System (UMTS) Terrestrial Radio Access Network (UTRAN) refers to a communications network including base stations, or Node Bs, and for example radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS). In case of E-UTRAN (enhanced UTRAN) no RNC exists and most of the RNC functionalities are contained in the eNodeB (evolved Node B, also called E-UTRAN Node B).

Long Term Evolution (LTE) or E-UTRAN refers to improvements of the UMTS through improved efficiency and services, lower costs, and use of new spectrum opportunities. In particular, LTE is a 3rd generation partnership project (3GPP) standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD). Advantages of LTE are, for example, high throughput, low latency, FDD and TDD support in the same platform, an improved end-user experience, and a simple architecture resulting in low operating costs.

Further releases of 3GPP LTE (e.g., LTE Rel-11, LTE-Rel-12) are targeted towards future international mobile telecommunications advanced (IMT-A) systems, referred to herein for convenience simply as LTE-Advanced (LTE-A). LTE-A is directed toward extending and optimizing the 3GPP LTE radio access technologies. A goal of LTE-A is to provide significantly enhanced services by means of higher data rates and lower latency with reduced cost. LTE-A will be a more optimized radio system fulfilling the international telecommunication union-radio (ITU-R) requirements for IMT-Advanced while keeping the backward compatibility.

### SUMMARY

One embodiment is directed to a method including defining, by a base station, a precoding vector switching (PVS) scheme for transmission of synchronization signals through multiple antennas comprising a plurality of pairs of cross-polarized antenna elements. The PVS scheme includes changing a direction pattern from co-polarized antenna elements for the first and for the second occurrence of the synchronization signals, and rotating a polarization from each of the pairs of cross-polarized antenna elements for the first and for the second occurrence of the synchronization signals.

Another embodiment includes an apparatus. The apparatus includes at least one processor, and at least one memory including computer program code. The at least one memory and computer program code, with the at least one processor, cause the apparatus at least to define a precoding vector switching (PVS) scheme for transmission of synchronization signals through multiple antennas comprising a plurality of pairs of cross-polarized antenna elements. The PVS scheme includes changing a direction pattern from co-polarized antenna elements for the first and for the second occurrence of the synchronization signals, and rotating a polarization from each of the pairs of cross-polarized antenna elements for the first and for the second occurrence of the synchronization signals.

Another embodiment is directed to a computer program embodied on a computer readable medium. The computer program is configured to control a processor to perform a process. The process includes defining a precoding vector switching (PVS) scheme for transmission of synchronization signals through multiple antennas comprising a plurality of pairs of cross-polarized antenna elements. The PVS scheme includes changing a direction pattern from co-polarized antenna elements for the first and for the second occurrence of the synchronization signals, and rotating a polarization from each of the pairs of cross-polarized antenna elements for the first and for the second occurrence of the synchronization signals.

### BRIEF DESCRIPTION OF THE DRAWINGS

For proper understanding of the invention, reference should be made to the accompanying drawings, wherein:

FIG. 1 illustrates an example of a precoding vector switching scheme, according to an embodiment;

FIG. 2 illustrates an example of forming direction patterns from co-polarized antenna elements, according to an embodiment;

FIG. 3 illustrates an example of rotation polarization from a pair of cross-polarized antennas, according to an embodiment;

FIG. 4 illustrates an example of possible antenna mapping schemes, according to an embodiment;

FIG. 5 illustrates an example of precoding vector switching schemes for four transmitter antennas, according to one embodiment;

FIG. 6 illustrates a flow diagram of a method, according to an embodiment; and

FIG. 7 illustrates an example of an apparatus, according to one embodiment.

### DETAILED DESCRIPTION

It will be readily understood that the components of the invention, as generally described and illustrated in the figures herein, may be arranged and designed in a wide variety of different configurations. Thus, the following detailed description of embodiments of methods, systems, apparatuses, and computer program products for transmission of synchronization signals, as represented in the attached figures, is not intended to limit the scope of the invention, but is merely representative of selected embodiments of the invention.

If desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Certain embodiments of the present invention are directed, for example, to methods, apparatuses, and/or computer program products for transmission of synchronization signals using multiple antenna techniques in the LTE downlink. LTE downlink synchronization signals are assigned to a single logical antenna port; while the operator can use multiple physical transmit antennas for extending the cell's coverage. One embodiment provides a UE-transparent multiple input multiple output (MIMO) transmitting scheme for synchronization signals.

To support synchronization in LTE, there are special downlink physical synchronization signals (primary and secondary), corresponding to a set of specially determined resource elements. Under the synchronization procedure of the UE, the timing and physical layer parameters are determined from the detection of synchronization signals. Though, correct detection of given physical layer parameters is important and plays a significant role in the cell coverage area.

In order to extend the cell's coverage area and the spectral efficiency under good propagation conditions, the operator may apply MIMO antenna technologies. However, the same single logical antenna port should be used for the synchronization signals, so the transmit antenna scheme should be fully UE-transparent such that the UE is not aware of the method the base station is using. As such, during detection of synchronization signals, the UE does not have any information about the transmitter (Tx) scheme (e.g., transmission mode and number of transmit antennas) and the base station has no channel state information. All of these features can obstruct application of typical MIMO solutions. In addition, the number of Tx antennas on the base station has a tendency to increase and the problem of more effective MIMO schemes becomes more crucial.

An initial proposed solution is to transmit the synchronization signals over a single antenna port. However, application of multiple transmitting antennas at the base station gives flexibility for operators in the transmitting scheme for the synchronization signals. If there are two or more Tx antennas on the base station, then transmitting of synchronization signals over one Tx antenna is not effective due to less radiating power.

Transmitting synchronization signals over all co-polarized antennas will result in forming azimuth directional pattern (i.e., beams) that should be optimized. If the distance between antenna elements is known, the operator can apply specific antenna weights to form the beamwidth pattern for the required sector. However, operators use antenna types from various vendors with different geometries, polarization properties and with various spacings of the single antenna dipoles in the antenna array. In this case, the weight vector should be tuned which is not a flexible solution. Also, it cannot be guaranteed that during installation the Tx antennas are always connected the same way. This means that antenna weights will be applied in an incorrect order leading to heavy deterioration.

As mentioned above, under the synchronization procedure of the UE, the timing and physical layer parameters are determined from detection of the LTE downlink synchronization signals. In order to extend the cell's coverage, the operator may apply MIMO antenna technologies. The primary synchronization signals (PSS) and secondary synchronization signals (SSS) can occur two times in a radio frame, while all necessary parameters can be detected from a single occurrence of the synchronization signals. Applying a MIMO transmission scheme can provide additional flexibility for the operator and, in addition, can result in benefits for the user detection algorithms. Since the same single antenna port is used for the secondary synchronization signals and for the primary synchronization signals, the transmit antenna scheme can be fully UE-transparent.

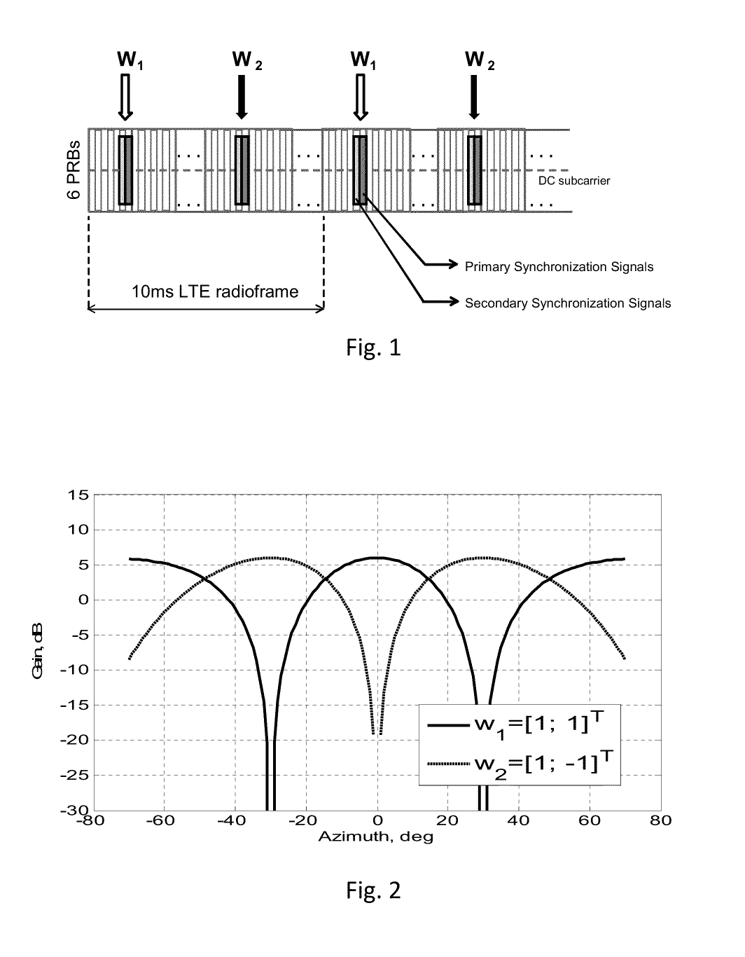

An example of such a scheme, which will provide MIMO benefits for synchronization signals, is precoding vector switching (PVS). FIG. 1 illustrates an example of a precoding vector switching scheme (PVS), according to one embodiment. In the example PVS illustrated in FIG. 1, one precoding vector is applied for the first occurrence of the synchronization signals in the radio frame and the second precoding vector is applied for the second occurrence of the synchronization signals. FIG. 1 illustrates the transmitted symbols over time for LTE. In the example of FIG. 1, at the end of the 1^{st} and 11^{th} slot of a radioframe, the primary and secondary synchronization symbols PSS/SSS are transmitted as indicated by the shaded rectangles in FIG. 1.

By the switching of various precodings, it is possible to switch the direction pattern in a manner that for azimuth ranges, having pattern nulls from the first precoding, the second precoding will cover them by pattern lobes. In addition, if cross polarized antennas are used for Tx, by selecting appropriate precoding it is also possible to set Tx wave as vertically polarized or horizontally polarized.

In order to achieve the best performance, the PVS scheme for downlink synchronization signals can be matched with the default antenna configuration on the Tx and receiver (Rx) side. Certain embodiments of the present invention define a specific precoding vector switching scheme for transmission of synchronization signals through multiple antennas comprised of several pairs of cross-polarized antenna elements. The configuration of Rx antennas is not necessarily specified and the precoding vector switching scheme is optimized for any configuration.

For several (e.g., two or more) pairs of cross polarized antennas, by adjusting the antenna weights, it is possible to control the antenna array performance according to the following rules: 1. Forming of a direction pattern from co-polarized antenna elements; and 2. Rotating polarization from each pair of cross polarized antennas. One embodiment includes PVS with changing the direction pattern (as denoted in rule 1 above) and polarization (as denoted in rule 2 above) for each occurrence of synchronization signals. Thus, by changing the pattern, the azimuth direction can be scanned. And, by rotating of polarization, it can be matched with UE antenna orientation. There are N antennas in total, and to operate by direction pattern, some embodiments adjust only by weight coefficients corresponding to the antenna elements with the same polarization. Similarly, to operate by rotation of polarization, certain embodiments consider only weight coefficients from each pair of cross polarized antennas.

FIG. 2 illustrates a graph depicting the forming of direction patterns from co-polarized antenna elements, for example, of 2 antennas. In the example of FIG. 2, the y-axis shows gain and the x-axis shows azimuth. By applying antenna weights w₁=[1; 1]^{T} and w₂=[1; −1]^{T} to the co-polarized antenna elements, two orthogonal patterns are formed. Each pattern has 6 dB directivity gain and there are several maximums uniformly distributed over the azimuth. As a result, the first occurrence of synchronization signals will be amplified for one azimuth ranges and the second occurrence of synchronization signals will be amplified for other azimuth ranges. In this example, total power normalization is not applied across antennas to ensure the same Tx power. Thus, if total power normalization should apply, that directivity gain will be 3 dB in comparison to one Tx antenna.

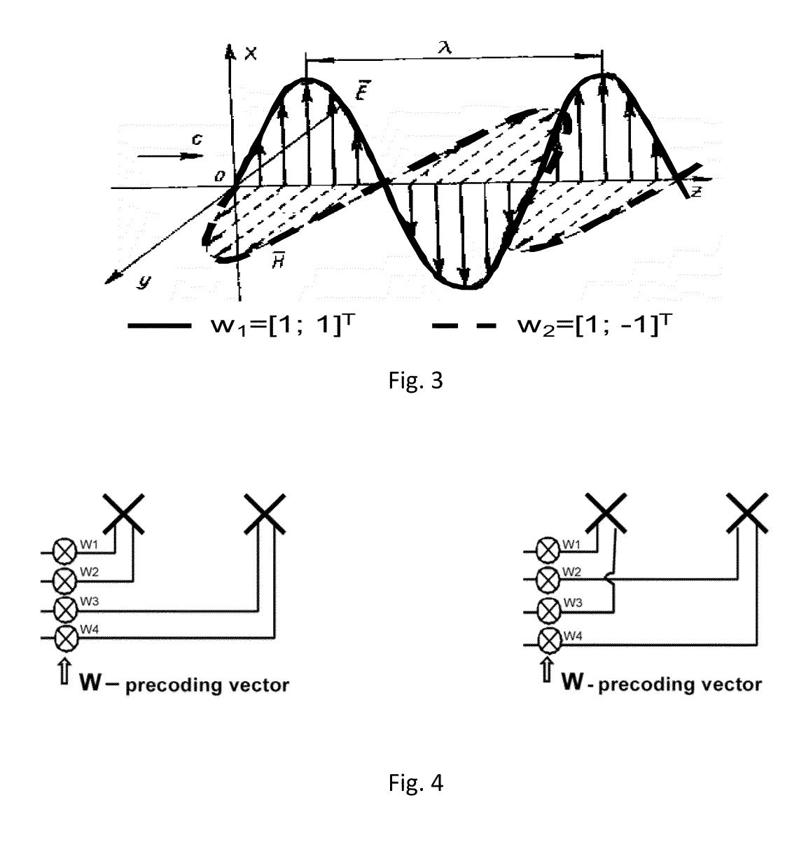

FIG. 3 illustrates a graph depicting the rotation polarization from a pair of cross-polarized antennas. This embodiment includes the application of weights to the pair of cross-polarized antennas. For default Tx cross-polarized antenna configuration) (−45°/45° the precoding [1; 1]^{T} means that Tx signal will be vertically polarized, while precoding [1; −1]^{T} means horizontal polarization for the output Tx signal, as illustrated in FIG. 3. Since most kinds of Rx antennas are linear polarized and its orientation highly depends on UE location, it may be important to maintain vertical and horizontal polarization components.

It should be noted that the starting point for the PVS method, according to certain embodiments, was that it cannot be guaranteed that during installation the Tx antennas are always connected in the correct manner. This means the PVS scheme provided according to certain embodiments is robust against cabling errors. Hence, it is not known which antenna inputs are mapped to the −45° or 45° polarizations. Thus, different antenna mapping schemes are possible. Two representative examples of different antenna mappings are illustrated in FIG. 4. In one example of FIG. 4, the antenna weights labeled w1 and w3 are mapped to co-polarized antenna elements; whereas, in the other example of FIG. 4, weights labeled w1 and w2 are mapped to co-polarized antennas. For closed loop transmission it has no effect, because it is taken into account during effective channel estimation. However, for the PVS method, the symmetry of precoding for both antenna mapping schemes is also taken into account.

Combining all the above mentioned aspects, the precoding vector switching scheme for an arbitrary number of transmitting antennas can be obtained. As an example, for four Tx antennas, one embodiment of the PVS scheme provides the following set of weights: w₁=[1; 1; −1; 1]^{T}; w₂=[1; −1; 1; 1]^{T}.

It is noted that embodiments of the PVS scheme combine the forming of a direction pattern from co-polarized antenna elements and the rotating of polarization from each pair of cross polarized antennas, in each precoding entity. Thus, for precoding w₁ there are two orthogonal patterns (formed by pairs of co-polarized antennas) and there are vertically and horizontally polarized Tx components (formed by different of cross polarized antennas). The same principles are used for the precoding w₂ but the antenna inputs are changed to achieve benefits from space-time diversity.

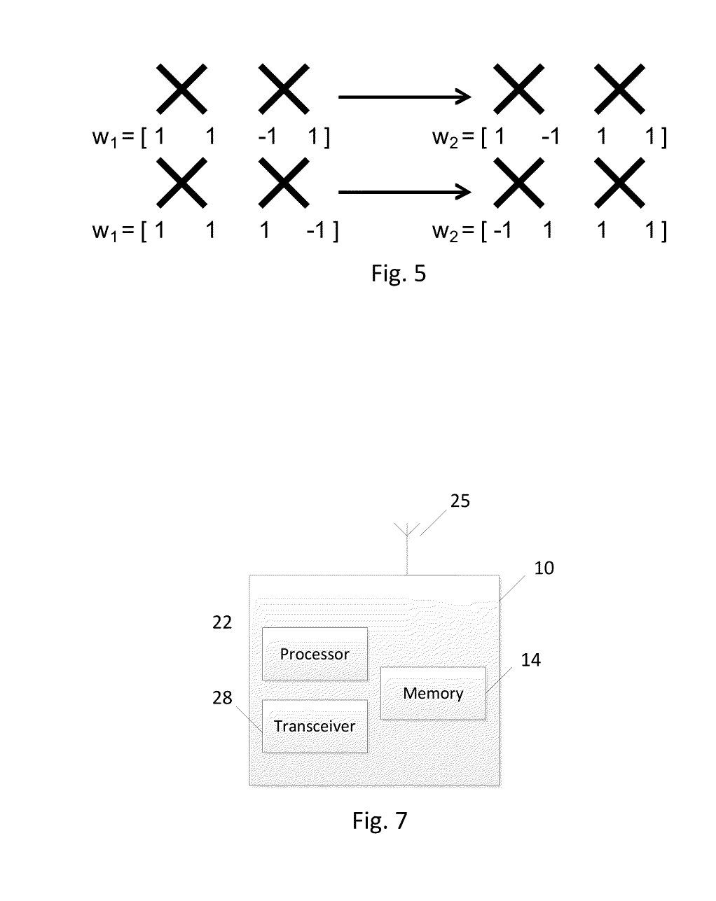

In one embodiment, in order to achieve maximal diversity order the weight “−1” may be changed in such a way that beam patterns and also polarizations should be switched to opposite. Thereby, weight “−1” would be better applied for different polarized antennas and different antenna units, as illustrated in FIG. 5. Also, embodiments for four Tx of synchronization signals can switch the following pair of weights: w₁=[1; 1; −1; 1]^{T}; w₂=[1; −1; 1; 1]^{T} or the following: w₁=[1; 1; 1; −1]^{T}; w₂=[−1; 1; 1; 1]^{T}.

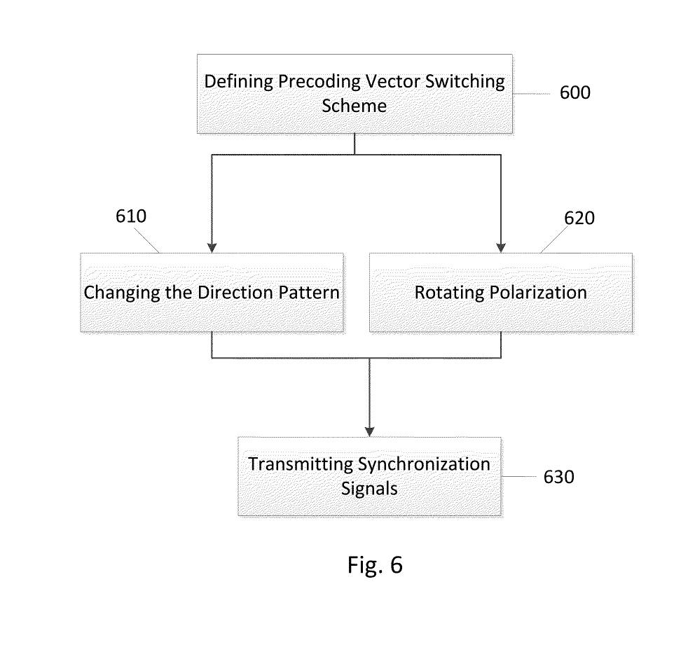

FIG. 6 illustrates a flow chart of a method according to one embodiment of the invention. The method includes, at 600, defining a PVS scheme for transmission of synchronization signals through multiple antennas including a plurality of pairs of cross-polarized antenna elements. The PVS scheme includes, at 610, changing the direction pattern from co-polarized antenna elements and, at 620, rotating the polarization from each pair of cross-polarized antenna elements. The method may further include, at 630, transmitting the synchronization signals to a UE, for example.

In one embodiment, the changing of the direction pattern from co-polarized antenna elements may include applying at least two antenna weights to the co-polarized antenna elements to form two orthogonal patterns. In an embodiment, each of the orthogonal patterns has 6 dB directivity gain. According to one example, the antenna weights applied to the co-polarized antenna elements may include w₁−[1; 1]^{T} and w₂=[1; −1]^{T}. In order to change the direction pattern, some embodiments adjust by weight coefficients corresponding to the antenna elements with the same polarization.

According to one embodiment, the rotating of the polarization from each pair of cross-polarized antenna elements may include applying antenna weights to at least one of the pairs of cross-polarized antenna elements.

In certain embodiments, the method illustrated in FIG. 6 may be performed by a network node, such as a base station, for example a LTE base station or eNodeB.

In some embodiments, the functionality of the flow diagram of FIG. 6, or that of any other method described herein, may be implemented by a software stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software. The computer readable media mentioned above may be at least partially embodied by a transmission line, a compact disk, digital-video disk, a magnetic disk, holographic disk or tape, flash memory, magnetoresistive memory, integrated circuits, or any other digital processing apparatus memory device.

FIG. 7 illustrates an example of an apparatus 10 according to an embodiment. In one embodiment, apparatus 10 may be a base station. It should be noted that one of ordinary skill in the art would understand that apparatus 10 may include components or features not shown in FIG. 7. Only those components or feature necessary for illustration of the invention are depicted in FIG. 7.

As illustrated in FIG. 7, apparatus 10 includes a processor 22 for processing information and executing instructions or operations. Processor 22 may be any type of general or specific purpose processor. While a single processor 22 is shown in FIG. 7, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 further includes a memory 14, which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas 25 for transmitting and receiving signals and/or data to and from apparatus 10. Apparatus 10 may further include a transceiver 28 configured to transmit and receive information. For instance, transceiver 28 may be configured to modulate information on to a carrier waveform for transmission by the antenna(s) 25 and demodulates information received via the antenna(s) 25 for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

As mentioned above, according to one embodiment, apparatus 10 may be a base station, such as a LTE base station or eNodeB. In an embodiment, apparatus 10 may be controlled, by memory 14 and processor 22, to define a PVS scheme for transmission of synchronization signals through multiple antennas including a plurality of pairs of cross-polarized antenna elements. The apparatus 10 may be further controlled, by memory 14 and processor 22, to change the direction pattern from co-polarized antenna elements and to rotate the polarization from each pair of cross-polarized antenna elements. The apparatus 10 may then be controlled, by memory 14 and processor 22, to transmit the synchronization signals to a UE, for example. According to an embodiment, apparatus 10 may be configured to transmit the synchronization signals in one cell via multiple antennas.

As mentioned above, according to an embodiment, the changing of the direction pattern from co-polarized antenna elements may include applying at least two antenna weights to the co-polarized antenna elements to form two orthogonal patterns. The rotating of the polarization from each pair of cross-polarized antenna elements may include applying antenna weights to at least one of the pairs of cross-polarized antenna elements.

By changing of the direction pattern and rotating the polarization for each occurrence of the synchronization signals, apparatus 10 is able to obtain a PVS scheme for an arbitrary number of transmitting antennas. In one embodiment, for example, with four Tx antennas the PVS scheme may provide the following set of weights: w₁=[1; 1; −1; 1]^{T}; w₂=[1; −1; 1; 1]^{T}. In another embodiment, the PVS scheme may provide the following set of weights: w₁=[1; 1; 1; −1]^{T}; w₂=[−1; 1; 1; 1]^{T}.

The described embodiments, features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

We claim:

1. A method, comprising:
defining, by a base station, a precoding vector switching (PVS) scheme for transmission of synchronization signals through multiple antennas comprising a plurality of pairs of cross-polarized antenna elements;
wherein the PVS scheme comprises:
changing a direction pattern from co-polarized antenna elements for a first and for a second occurrence of the synchronization signals; and
rotating a polarization from each of the pairs of cross-polarized antenna elements for the first and for the second occurrence of the synchronization signals.

2. The method according to claim 1, further comprising:
transmitting the synchronization signals to a user equipment.

3. The method according to claim 1, wherein the changing of the direction pattern from the co-polarized antenna elements comprises applying at least two antenna weights to the co-polarized antenna elements to form two orthogonal patterns.

4. The method according to claim 1, wherein the rotating of the polarization from each of the pairs of cross-polarized antenna elements comprises applying at least two antenna weights to the pairs of cross-polarized antenna elements to form two orthogonal polarizations.

5. The method according to claim 3, wherein the antenna weights applied to the co-polarized antenna elements comprise w₁=[1; 1]^{T} and w₂=[1; −1]T.

6. The method according to claim 3, wherein the multiple antennas comprise four Tx antennas, and the antenna weights comprise w₁=[1; 1; −1; 1]^{T} and w₂=[1; −1; 1; 1]^{T}.

7. The method according to claim 3, wherein the multiple antennas comprise four Tx antennas, and the antenna weights comprise w₁=[1; 1; 1; −1]^{T}; w₂=[−1; 1; 1; 1]^{T}.

8. An apparatus, comprising:
at least one processor; and
at least one memory comprising computer program code,
the at least one memory and the computer program code configured, with the at least one processor, to cause the apparatus at least to
define a precoding vector switching (PVS) scheme for transmission of synchronization signals through multiple antennas comprising a plurality of pairs of cross-polarized antenna elements;
wherein the PVS scheme comprises:
changing a direction pattern from co-polarized antenna elements for a first and for a second occurrence of the synchronization signals; and
rotating a polarization from each of the pairs of cross-polarized antenna elements for the first and for the second occurrence of the synchronization signals.

9. The apparatus according to claim 8, wherein the at least one memory and the computer program code are further configured, with the at least one processor, to cause the apparatus at least to:
transmit the synchronization signals to a user equipment.

10. The apparatus according to claim 8, wherein the at least one memory and the computer program code are further configured, with the at least one processor, to cause the apparatus at least to change the direction pattern from the co-polarized antenna elements by applying at least two antenna weights to the co-polarized antenna elements to form two orthogonal patterns.

11. The apparatus according to claim 8, wherein the at least one memory and the computer program code are further configured, with the at least one processor, to cause the apparatus at least to rotate the polarization from each of the pairs of cross-polarized antenna elements by applying at least two antenna weights to the pairs of cross-polarized antenna elements to form two orthogonal polarizations.

12. The apparatus according to claim 10, wherein the antenna weights applied to the co-polarized antenna elements comprise w₁−[1; 1]^{T} and w₂[1; −1]^{T}.

13. The apparatus according to claim 10, wherein the multiple antennas comprise four Tx antennas, and the antenna weights comprise w₁=[1; 1; −1; 1]^{T} and w₂=[1; −1; 1; 1]^{T}.

14. The apparatus according to claim 10, wherein the multiple antennas comprise four Tx antennas, and the antenna weights comprise w₁=[1; 1; 1; −1]^{T}; w₂=[−1; 1; 1; 1]^{T}.

15. The apparatus according to claim 8, wherein the apparatus comprises a base station.

16. A computer program, embodied on a computer readable medium, wherein the computer program is configured to control a processor to perform a process, comprising:
defining a precoding vector switching (PVS) scheme for transmission of synchronization signals through multiple antennas comprising a plurality of pairs of cross-polarized antenna elements;
wherein the PVS scheme comprises:
changing a direction pattern from co-polarized antenna elements for a first and for a second occurrence of the synchronization signals; and
rotating a polarization from each of the pairs of cross-polarized antenna elements for the first and for the second occurrence of the synchronization signals.
